(19) United States
(12) Patent Application Publication
(10) Pub. No.: US 2010/0219355 A1
(43) Pub. Date: Sep. 2, 2010

(54) Apparatus for an Irradiation Unit

(75) Inventor: Sven Linow, Darmstadt (DE)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: Heraeus Noblelight GmbH, Hanau (DE)

(21) Appl. No.: 12/682,413

(22) PCT Filed: Sep. 23, 2008
(86) PCT No.: PCT/EP2008/008045

§ 371 Date: Apr. 9, 2010

(30) Foreign Application Priority Data
Oct. 9, 2007 (DE) 10 2007 048 564.8

(51) Int. Cl. G21K 5/02

(52) U.S. Cl. 250/492.1

(57) ABSTRACT

An apparatus is provided having a chamber for the irradiation of at least one substrate. The apparatus includes a transfer channel for inserting and removing the substrate, a substrate holder inside the chamber, a vacuum pump, and at least one irradiation unit for irradiating the substrate. The irradiation unit has at least one infrared emitter including an integrated reflector.

### CROSS-REFERENCE TO RELATED APPLICATIONS

This application is a Section 371 of International Application No. PCT/EP2008/008045, filed Sep. 23, 2008, which was published in the German language on Apr. 23, 2009, under International Publication No. WO 2009/049752 A1 and the disclosure of which is incorporated herein by reference.

### BACKGROUND OF THE INVENTION

The invention relates to an apparatus for irradiating at least one substrate, wherein the apparatus has an irradiation unit with at least one infrared emitter.

Many processes need a vacuum for optimal conditions. For this purpose, a substrate must first be transferred into the vacuum. Frequently, a preparation step is then added before the substrate is then processed in the vacuum. Typical processes are the deposition of coatings on a wide variety of different materials by means of a wide variety of different processes. Here, metal parts or even endless metal belts, glass panes, semiconductor substrates, etc. are used as the substrates. Typical coating processes are chemical vapor deposition (CVD), plasma etching, sputtering by plasma coating methods, etc.

For this purpose, the substrate very often must be specially conditioned during or after the transfer into the vacuum apparatus. This conditioning includes, among other things, heating. Heating is performed in order to avoid, e.g., the coating of the surface with water molecules, which could be harmful for the process or the vacuum. For this purpose, the substrate is typically heated to temperatures between 140° C. and 300° C., so that water molecules can be converted to the gas phase. For a series of coating methods, reaching a specified substrate temperature is itself also a prerequisite for the optimal execution of the process and must be set by the conditioning.

Heating processes could also be used in addition after a vacuum process.

All of these applications have in common that an effective heating of a substrate should be performed in an environment that is at least partially in time or space a vacuum, that the efficiency of the heating should be as high as possible due to the infrared emitters being used, and that the reflectivity values of the materials involved and surfaces of the chambers and the infrared emitters contribute decisively to the efficiency and to the costs of the system itself.

Usually, these processes are batch processes, because material must be introduced into the processing chamber by transfer channels or locks, in order to keep the environmental conditions in the chamber constant. An additional difficulty of such batch processes is that all of the substrates must leave the heating phase at the same temperature and conditioning. Usually, the processing window of such systems is tightly scheduled, so that small deviations result in a substrate becoming a reject. Nevertheless, in the case of typical systems, the processing stage must then still be passed through, in order to be transferred outward, so that considerable costs are generated. A heating stage in the vacuum process must feature, for one, very high heating rates, in order to achieve fast passage times, but at the same time it must be able to react very quickly, in order to be able to react flexibly to changing heating times. In particular, overheating of the substrate has to be avoided, as might be generated, e.g., due to large thermal mass or high heating inertia of the system.

Various approaches from the state of the art are known, in order to subject substrates to irradiation and thermal treatment. Only heating by means of irradiation can be used successfully in a vacuum and in the case of sensitive surfaces.

Thus, for example, there are heating elements that feature a stainless steel tube, which is heated electrically from the inside and thus can reach temperatures of about 600° C. Such metal heating elements have sufficient chemical resistance in vacuum, are cost-effective, show outstanding properties for vacuum processes, but show extremely slow thermal reaction and cannot emit high output power due to the low maximum surface temperature. If oxygen is present at any time during the process in the environment around these heating elements, then the elements become tarnished and change their emission behavior.

Furthermore, infrared emitters are known from the state of the art consisting of a vacuum-tight sealed quartz tube and heating conductors arranged therein. The heating conductors are typically made from tungsten or carbon. Such infrared emitters are usually very swift in their thermal reaction: their infrared output is instantaneously available and can be quickly regulated, and they reach considerable radiation power. For reaching this high radiation power of each individual emitter, for vacuum applications rather high voltages are necessary. Both metal tube heating elements and infrared emitters emit their output power uniformly into all spatial directions and therefore achieve only an unsatisfactory process efficiency.

Furthermore, from the state of the art, such infrared emitters are known in combination with external reflectors. Here, usually polished sheets made of stainless steel, molybdenum, or aluminum are used as the external reflectors. With such external reflectors, a certain portion of the output of the emitter can be reflected back onto the substrate, which results in an increase in efficiency. These sheets absorb a portion of the incident radiation and thus store large quantities of heat. Furthermore, due to residual quantities of oxygen or some process gases (e.g., selenium), they often become tarnished, which leads to a strong reduction in the reflectivity and to strong additional heating of the sheets. The result is likewise an increasing thermal inertia of the radiation source and thus of the system, as well as reduced efficiency.

In the prior art, among other things, reflectors are described made from powder composed of aluminum oxide (Al₂O₃) or zirconium oxide (ZrO₂) sintered onto the emitter tube. These reflectors are deposited directly on the emitter tube and cannot oxidize. Such reflectors made from aluminum oxide or zirconium oxide tend to flake and are thus a source of impurities. Since they are open-pored materials, during cyclical operation they can bind large quantities of gases and then release them again under heating. Process gases, as for example selenium, settle in the open pores and then destroy the reflective effect of the material. Their reflective effect is limited with typical values of 30%. They are thus not recommended for the described applications.

IR emitters with reflectors made from gold are known, but cannot be used, because the gold reflector breaks down within a very short time in a vacuum, due to the low pressure and the high temperature of the quartz tube of the emitter. The quartz tube of the emitter cannot be cooled by air ventilation.

Especially in the pressure range around 1 mbar, a transition range, that is reached in each vacuum transfer channel at one time or at one location, voltage flashovers and destructive gas discharges are generated when voltages of approximately more than 100 V are exceeded for typical geometries. This limits the output power or the maximum length of the heating filament of IR emitters.

European patent application publication EP 1 228 668 A1 describes IR emitters, which are inserted into additional casing tubes made from quartz glass, wherein these casing tubes are sealed vacuum-tight relative to the vacuum chambers. In this way, it is possible that each of the individual emitters can be operated at high voltages. In principle, with sufficient cooling, a highly efficient gold reflector can also be deposited on the individual emitter. A disadvantage of this apparatus, however, is that a cooling of the individual emitters or the tube has proven to be difficult, since a temperature gradient in the emitter or in the casing tube is always introduced in the direction of the cooling fluid through-flow (air). Therefore, temperature gradients are formed in the substrate, which are undesired and have negative effects or even lead to rejects.

The use of IR transparent cooling fluids for such a geometry and emitter arrangement is described in German published patent application DE 10 2004 002 357 A1. A disadvantage is the high technical expense for the implementation of an additional, gas-tight cooling circuit to be operated at low pressure.

In European patent application publication EP 1 071 310 A1, a device for the homogeneous heating of silicon wafers in a vacuum is described. Here, a plurality of round infrared emitters is arranged in front of an external reflector and cooled by means of directional air flow. Here, the emitters and the air cooling are separated by means of a window facing the actual processing chamber with its substrate.

In European Patent EP 1 089 949 B1, a chamber is described in which the substrate is arranged together with the infrared emitter between two reflectors. The reflectors are here made of thin sheet metal, preferably of aluminum. The cooling of the reflector is achieved in that this is blackened on the rear side, so that a heat transport can take place via radiation from the reflector to the cooled wall. An additional control of the temperature of the substrate is performed by the addition of a heat-conductive gas, so that in addition to the heat transport by radiation, a heat transport via heat conduction and free convection, the heat from the substrate reflector and emitter can be dissipated to the cooled chamber wall.

The devices named above all have the disadvantage that they have a large thermal inertia and are thus not implicitly suitable for the quick heating and holding of a sample at a defined temperature.

### BRIEF SUMMARY OF THE INVENTION

The object of the invention is therefore to provide an apparatus that avoids the disadvantages mentioned above and allows a quick heating as well as a subsequently long holding of the substrate at a defined temperature.

The apparatus according to the invention having a chamber for the irradiation of at least one substrate comprises at least one transfer channel for inserting and removing the substrate, a substrate holder inside the chamber, a vacuum pump, and at least one irradiation unit for irradiating the substrate, wherein the irradiation unit has at least one infrared emitter with an integrated reflector.

Such an apparatus allows the chamber to be constructed significantly smaller in comparison with previously known chambers, since the infrared emitter is already provided with an integrated reflector, and thus an external reflector and counter reflector, which usually require a lot of space, can be eliminated.

It has been shown, furthermore, that the use of such an emitter in such a chamber results in the chamber being able to be constructed faster with respect to its thermal reaction rate, and thus better results are achieved during the irradiation of the substrate. Also, with such an emitter, heating and cooling with the apparatus according to the invention is enabled and simultaneously, thermal inertia is minimized.

As the chamber, any chamber could be used that is suitable for the absorption and thermal treatment of a substrate, as described, for example, in EP 1 089 949 B1.

It has been shown that it is advantageous if the reflector is made of a material that is transparent in a broadband at least in the dense state particularly for radiation in the near and medium infrared range, but is applied as an opaque material. This reflector has an especially high reflectivity and provides very good properties with respect to mechanical stability and vacuum suitability.

It is also advantageous if the reflector has a closed-pore structure.

It is advantageous when a coating is applied on the reverse side of the infrared emitter and the coating here exhibits a high absorption in the far infrared range. It has been shown that a coating comprising quartz glass is especially suitable for this purpose.

This material has a very high temperature resistance.

An apparatus according to one embodiment of the invention results in that, for example, the cooled vacuum chamber is constructed as the single additional reflector of the apparatus.

This contributes, in turn, to material savings and thus to cost reduction.

The reflector described above is thus optimally suitable for use in a vacuum chamber, because it is highly efficient and vacuum compatible. It furthermore has minimal tendency for discharging gases, since it can barely store any.

With the apparatus according to the invention, it has been further shown that tarnishing and/or oxidation of such a chamber can be prevented, because absolutely no components are present that are at a temperature at which they can be tarnished or oxidized.

It is advantageous if the emitter is removable from the chamber.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. Shown in the drawings in schematic diagram are:

FIG. 1 is an axial emission behavior diagram of a typical IR emitter with Al₂O₃ coating;

FIG. 2 is a series of axial emission behavior diagrams of typical short-wave IR emitters for different reflector types;

FIG. 3 is a series of axial emission behavior diagrams of typical carbon IR emitters for different reflector types;

FIG. 4 is a cross-sectional elevation view of a device according to an embodiment of the invention; and

FIG. 5 is a cross-sectional elevation view of a further embodiment of a device according to the invention.

### DETAILED DESCRIPTION OF THE INVENTION

In order to be able to evaluate the emission behavior of reflector types, a device is used that detects within a broadband the total incident radiation output by means of a thermopile sensor. This sensor is guided in a circle about the emitter axis and thus records a measurement value every 5°. The measurements are performed in air. From these measurements a reflectivity R of the reflector can also be calculated during operation, with this reflectivity being defined as

$$R = 1 - \frac{{I}_{reflector} }{{I}_{total}} \cdot \frac{{n}_{total}}{{n}_{reflector}} = \frac{{I}_{usefulside}}{{I}_{total}} \cdot \frac{{n}_{total}}{{n}_{usefulside}}$$

where Iₜₒₜₐₗ is the total discharged intensity and I_{reflector} is the intensity discharged from the reflector side, summed across the respective measurements; nₜₒₜₐₗ is the number of total measurements and n_{reflector} is the number of measurements on the reflector side. I_{useful side} is the summed intensity and n_{useful side} is the number of measurement points on the useful side.

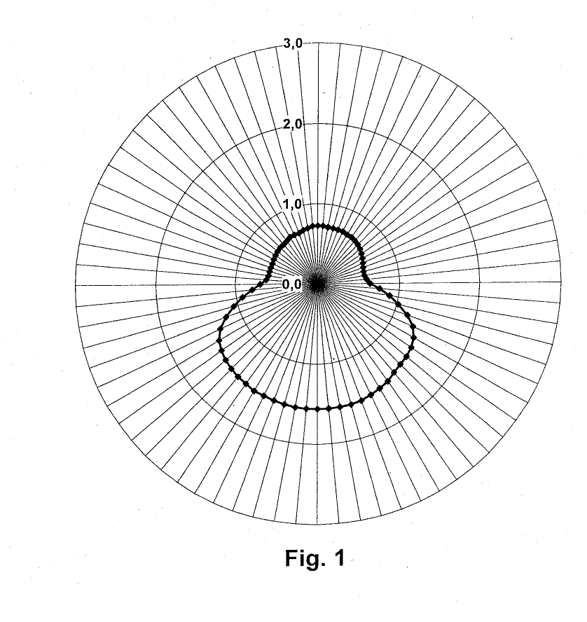

In FIG. 1 the measurement result is illustrated for a conventional halogen round tube emitter having 180° coating of the tube with sprayed-on Al₂O₃ powder as the IR reflector. The reflectivity equals 32% for these data and is even smaller in vacuum, where the Al₂O₃ is hotter due to the lack of convective cooling. The coating is arranged at the top in FIG. 1.

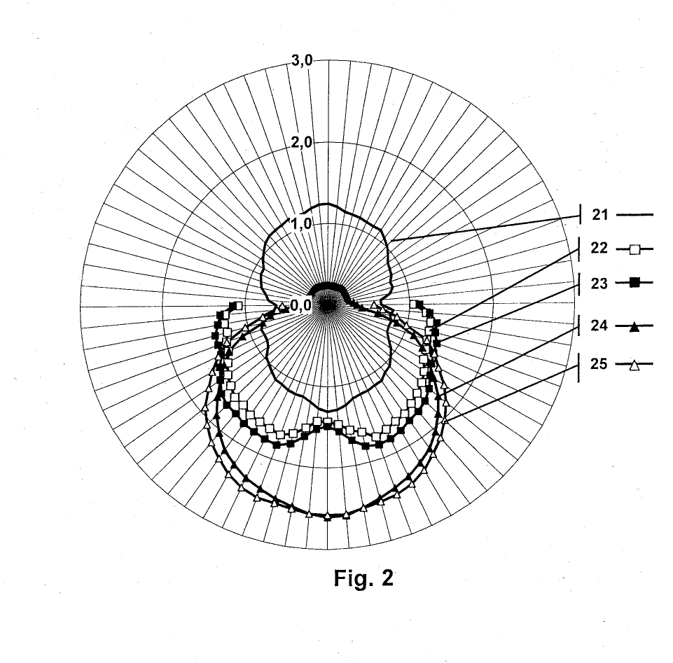

In FIG. 2 a comparison is shown for a series of reflector types for mechanically more stable twin tube emitters, wherein tungsten was always used as the heating filament.

Here, the lines reproduce each measurement result for different reflector types:

Line 21:→a twin tube without reflector

Line 22:→a stainless steel reflector

Line 23:→an aluminum reflector

Line 24:→a reflector according to the invention on a twin tube

Line 25:→a reflector according to the invention on a twin tube and in front of an aluminum reflector.

A twin tube designates an IR emitter without a reflector. Such an emitter was then measured in front of a pristine high-gloss stainless steel reflector and a pristine high-gloss aluminum reflector, wherein each could then be measured only over 180° in front of the reflector. Furthermore, an irradiation unit having an emitter and having a reflector were measured over 360°, as well as an irradiation unit having an emitter and having a reflector in front of a pristine high-gloss aluminum reflector. All of the reflector layers are applied at the top in FIG. 2 between 3 and 9 o' clock.

Reflectivity values that resulted were 50% for the pure stainless steel 22, 61% for aluminum 23, 74% for the reflector of the irradiation unit 24 according to the invention, and 87% for the reflector and aluminum irradiation unit 25 according to the invention. For the 180° measurements, in each case the Iₜₒₜₐₗ from the measurement without the reflector was used. The reflectivity values of the metallic reflectors are thus lower than the theoretical values, because a considerable portion of the irradiation is reflected back onto the emitter.

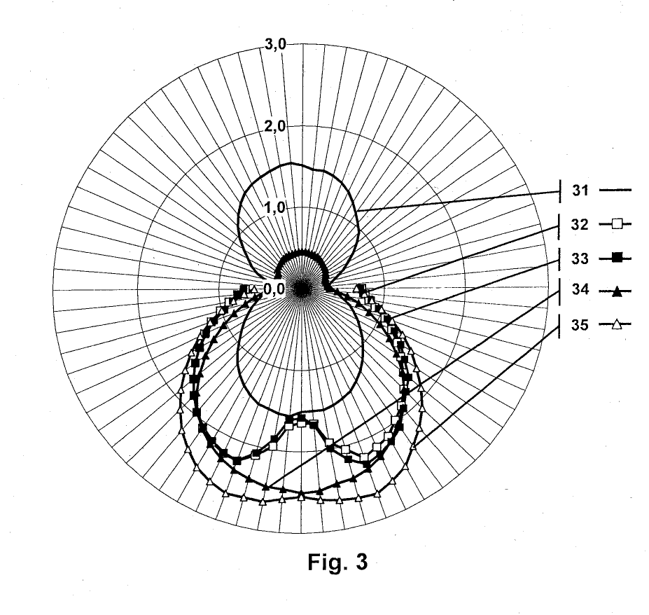

In FIG. 3 a comparison is shown for a series of reflector types, for mechanically more stable twin tube emitters, wherein carbon was used as the heating filament.

Here, the lines reproduce each measurement result for different reflector types:

Line 31:→a twin tube without reflector

Line 32:→a stainless steel reflector

Line 33:→an aluminum reflector

Line 34:→a reflector according to the invention on a twin tube

Line 35:→a reflector according to the invention and aluminum reflector.

A twin tube designates an IR emitter without a reflector. Such an emitter was then measured in front of a pristine high-gloss (stainless steel) reflector and a pristine high-gloss (aluminum) reflector, wherein each could then be measured only over 180° in front of the reflector. Furthermore, an irradiation unit having an emitter and having a reflector over 360°, as well as an irradiation unit having an emitter and having a reflector, were measured in front of a novel pristine high-gloss (aluminum) reflector. All of the reflector layers are deposited at the top in FIG. 3 between 3 and 9 o' clock.

Reflectivity values that resulted were 61% for the pure stainless steel 32, 63% for aluminum 33, 64% for the reflector of the irradiation unit 34 according to the invention, and 91% for the reflector and aluminum irradiation unit 35 according to the invention. For the 180° measurements, in each case Iₜₒₜₐₗ from the measurement without the reflector was used. The reflectivity values of the metallic reflectors are lower than the theoretical values, because a considerable portion of the radiation is reflected back onto the emitter.

Because most substrates have an angular dependency of the reflectivity and this increases for grazing angles of incidence, only the contributions inciding within an angular range of about 45° about the normal to the substrate are available for effective heating. For this reason, the irradiation unit having an emitter and having a reflector as described in the invention are even more effective, because they have not only significantly higher effectiveness, as pristine external reflectors, but even limit the radiation primarily to the process-relevant angular range.

### Embodiment 1

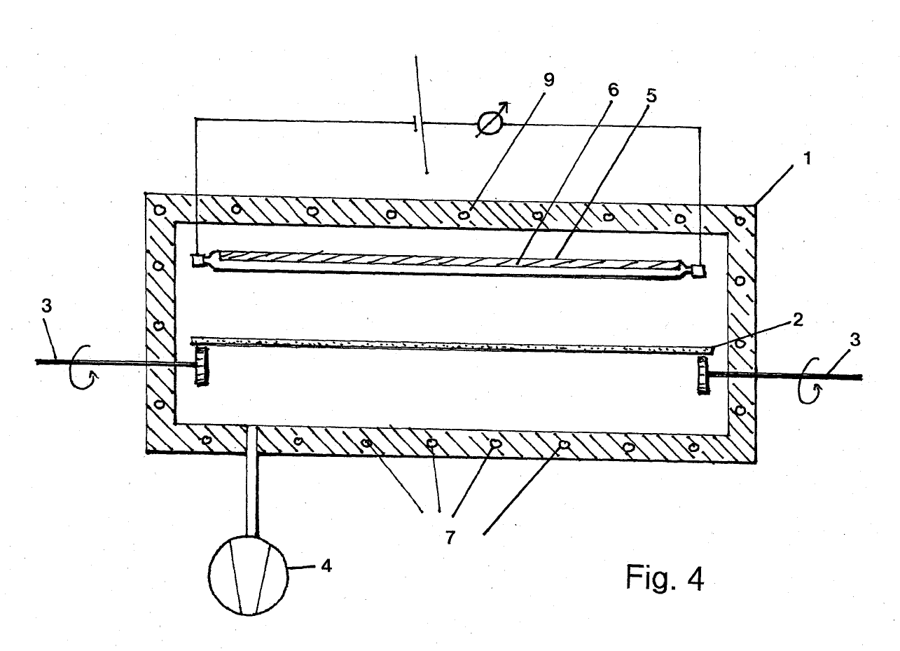

In FIG. 4 an apparatus according to a first embodiment of the invention is shown in cross section. In a vacuum chamber 1 a substrate 2 is advanced by suitable devices 3 on rollers perpendicular to the plane of FIG. 4. The loading transfer channels or locks, as well as other processing chambers, are not shown. The gas pressure within the chamber 1 is regulated by suitable pumps 4, when the locks are closed relative to atmosphere. The irradiation units with an emitter 5 having a reflector layer 6 are arranged above the substrate 2. In the entire wall of the chamber, cooling channels 7 are formed, which allow the chamber wall to be kept at a constant temperature. The chamber inner walls are made from blank, preferably polished metal (aluminum or stainless steel). For this purpose, the completed chamber 1 is finally processed from the inside. The chamber 1 constructed in this way is extremely simple in production and very accessible, since only a few components are arranged in its interior. At the same time, it has a very high efficiency in heating, since almost no radiation reaches and heats primarily the chamber wall or other installed parts. The chamber wall maintains its relatively high reflectivity (depending on material and emitter >65%), because it is cooled and thus cannot become tarnished. Since there are nearly no masses present in the chamber 1 that must be heated or cooled, except for the emitter 5 itself, the entire apparatus will react very fast in terms of heating power. The emitters consist almost exclusively of quartz glass having a mass of 2.2 g/cm³ and of the reflector according to the invention having a density of approximately 1.75 g/cm³. Typically starting at a material thickness of 3 mm, the substrate 2 itself is the part of the apparatus having the highest thermal inertia, as is desired.

### Embodiment 2

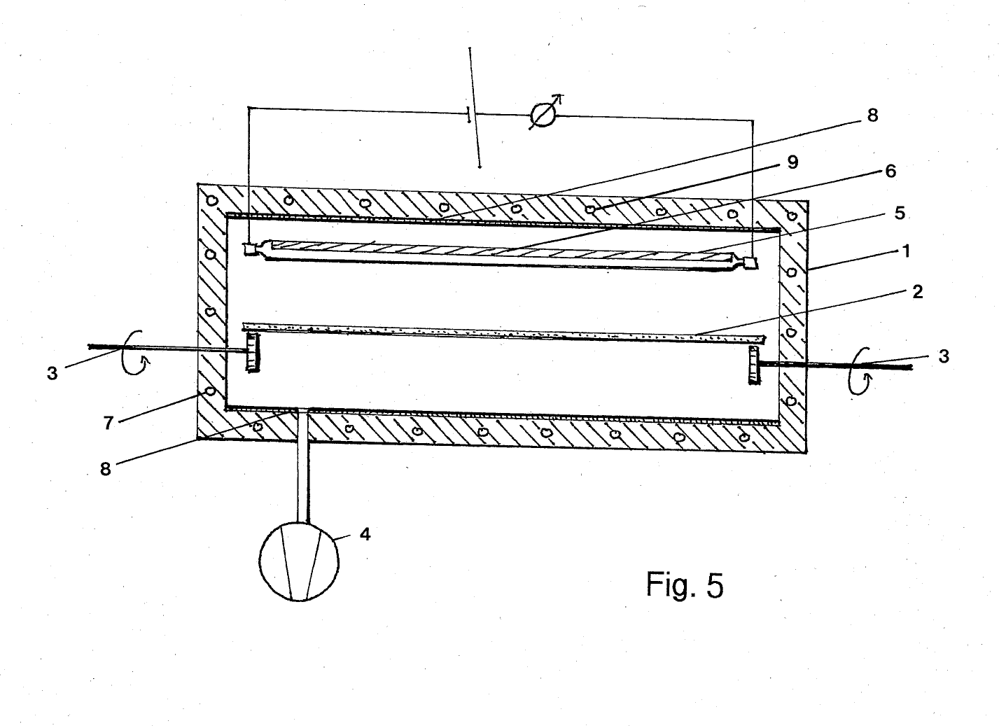

FIG. 5 shows an apparatus according to the invention in which the radiation cooling between the emitter 5 and chamber 1, as well as substrate 2, is optimized. For this purpose, the two large surfaces 9 have also been coated with a transparent or translucent layer 8, which exhibits similar absorption properties, such as quartz glass. Thus, the useful radiation in the range between 400 nm and 4000 nm is essentially reflected back into the chamber 1, since the layer 8 transmits the radiation to the metallic, reflective chamber wall, but at the same time the radiation occurring at higher wavelengths is effectively absorbed by the chamber by the layer 8.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1.-14. (canceled)

15. An apparatus having a chamber for irradiation of at least one substrate, the apparatus comprising:
at least one transfer channel for inserting and removing the substrate into and from the chamber,
a substrate holder inside the chamber,
a vacuum pump,
and at least one irradiation unit for irradiating the substrate, wherein the irradiation unit includes at least one infrared emitter having an integrated reflector.

16. The apparatus according to claim 15, wherein the reflector comprises a material transparent over a broad band in the visible and infrared ranges, but is applied as an opaque layer.

17. The apparatus according to claim 16, wherein the material of the reflector is transparent in a non-opaque state in a wavelength range from 780 nm to 2200 nm.

18. The apparatus according to claim 17, wherein the wavelength range is from 400 nm to 2700 nm.

19. The apparatus according to claim 17, wherein the wavelength range is from 400 nm to 5000 nm.

20. The apparatus according to claim 15, wherein a coating is deposited on the reverse side of the infrared emitter.

21. The apparatus according to claim 20, wherein the coating has high emissivity in the far infrared range.

22. The apparatus according to claim 20, wherein the coating comprises quartz glass.

23. The apparatus according to claim 15, wherein the reflector is constructed as a vacuum-suitable reflector.

24. The apparatus according to claim 15, wherein the infrared emitter is removable from the chamber.

25. The apparatus according to claim 15, wherein the chamber has a wall constructed as a reflector.

26. The apparatus according to claim 15, wherein at least parts of an inner wall of the chamber are provided with a transparent or translucent layer having a high absorption in the far infrared range above 2200 nm.

27. The apparatus according to claim 26, wherein the high absorption is in the far infrared range above 2700 nm.

28. The apparatus according to claim 26, wherein the high absorption is in the far infrared range above 5000 nm.

29. The apparatus according to claim 15, further comprising a coating of the chamber wall selected from glass, quartz glass, and Al₂O₃.

30. The apparatus according to claim 15, wherein the substrate is automatically movable in the chamber before or during the irradiation.

31. The apparatus according to claim 15, comprising a plurality of infrared emitters arranged to achieve a most homogeneous distribution possible across a surface area of the substrate for radiation penetrating into the substrate and heating the substrate.
